(19) United States
(12) Patent Application Publication
(10) Pub. No.: US 2017/0180231 A1
(43) Pub. Date: Jun. 22, 2017

(54) MONITORING QUEUES AT SWITCHES OF A NETWORK FROM AN EXTERNAL ENTITY

(71) Applicant: International Business Machines Corporation, Armonk, NY (US)

(72) Inventors: Andreea Simona Anghel, Adliswil (CH); Mitch Gusat, Zurich (CH); Georgios Kathareios, Zurich (CH)

(21) Appl. No.: 14/975,893

(22) Filed: Dec. 21, 2015

(51) Int. Cl. H04L 12/26; H04L 12/861

(52) U.S. Cl. CPC H04L 43/0876; H04L 49/90

(57) ABSTRACT

The present invention is notably directed to a computer-implemented method for monitoring a computerized network. Said network comprises several switches that are, each, configured for processing data queuing thereat. The method comprises monitoring queues of data at switches of the network at an entity external to and in communication with the network. Monitoring is carried out by first sending, via a data path of the network, an execution data packet to each of the switches. The execution data packet comprises contents interpretable by said each of the switches so as for the latter to start and/or stop an execution of a sampling mechanism for sampling a queue of data at said each of the switches and returning sampled data to the external entity. Eventually, data sampled according to this sampling mechanism are received at the external entity (from each of the switches, and via said data path). The present invention is further directed to related methods and computer program products.

### BACKGROUND

The invention relates in general to the field of computer-implemented methods for monitoring queues at switches of a network.

Today's clouds are based on large aggregations of hardware (servers, storage, networks) and software (software-defined networking [SDN], hypervisors, operating systems [OSs], applications). Distributed scale out systems, i.e., in datacenters (DCs), are typically virtualized in order to serve multiple tenants and their users. The orchestration, management, load balancing, protection and isolation of such virtualized systems depend on timely access to the DCs internal states (load, occupancy, utilization, etc.), including all the layers of the physical and virtual components.

However, it can be realized that current systems make it difficult, if not impossible to simultaneously observe (and a fortiori control) the state of two or more queues of data queuing at switches of a network, at packet resolution. Hence the direct observation of multitude of queues is not (or hardly) possible inside a datacenter's network, be it a physical fabric or a virtualized SDN overlay, particularly at the temporal granularity of a few packets (nanosecond to microsecond scale). Therefore, schemes for building a space-time correlated global sampling system for a multitude of queues, as suggested in A. S. Anghel, R. Birke, and M. Gusat (“Scalable High Resolution Traffic Heatmaps: Coherent Queue Visualization for Datacenters”), TMA 2014: [26-37], remain of limited theoretical relevance.

### SUMMARY

According to a first aspect, the present invention is embodied as a computer-implemented method for monitoring a computerized network. Said network comprises several switches that are, each, configured for processing data queuing thereat. The method comprises monitoring queues of data at switches of the network, from an entity external to and in communication with the network. Monitoring is carried out by first sending, via a data path of the network, an execution data packet to each of the switches. The execution data packet comprises contents interpretable by each switch so as for the latter to start and/or stop an execution of a sampling mechanism for sampling a queue of data and returning sampled data to the external entity. Eventually, data sampled according to this sampling mechanism are received at the external entity (from each of the switches, and via said data path).

Preferably, the execution data packet sent comprises contents interpretable so as for said each of the switches to start the execution of the sampling mechanism for sampling said queue during a defined time period. The time period may possibly be defined according to contents of the execution data packet sent, and may further he adjusted over time according to previously sampled data, as collected from the switches.

A prior configuration of the switches may be advantageous. I.e., in embodiments, a configuration data packet is sent (prior to sending the execution data packet) to each of the switches, via a control path of the network. This configuration data packet is interpretable so as for each of the switches to set configuration parameters for the subsequent sampling mechanism. Such parameters may include conditions, which, if met, will trigger the subsequent sampling mechanism.

According to another aspect, the invention is embodied as a computer-implemented method for enabling an entity external to and in communication with a computerized network to monitor queues of data at switches of a network such as evoked above. This method basically comprises, at each of the switches of the network: receiving, via a data path of the network, an execution data packet; starting and/or stopping an execution of a sampling mechanism for sampling a queue of data at said each of the switches, according to contents of the execution data packet received; and returning, via said data path, data sampled according to said sampling mechanism to the external entity. The data sampled are preferably timestamped.

As evoked above, the switches may, during a configuration phase, set configuration parameters for the subsequent sampling mechanism and this, based on contents of configuration data packets sent to that aim by the external entity.

Preferably, the starting and/or stopping the execution of the sampling mechanism is performed at each of the switches according to a finite-state machine.

According to a final aspect, the invention can be embodied as a computer program product, comprising program instructions executable so as to cause an external entity to monitor queues of data, by performing steps such as described above.

Computerized devices, systems, methods and computer program products embodying or implementing steps according to the present invention will now be described, by way of non-limiting examples, and in reference to the accompanying drawings.

### BRIEF DESCRIPTION OF SEVERAL VIEWS OF THE DRAWINGS

FIG. 1 is a flowchart illustrating high-level steps of a method for monitoring a computerized network, according to embodiments, wherein steps performed by an external (monitoring) entity are distinguished from steps performed by switches of the network;

FIG. 2 is a flowchart illustrating high-level steps of a method for monitoring a computerized network, according to embodiments, wherein steps carried out during a configuration phase are distinguished from steps performed during an execution phase (sampling phase);

FIG. 3 shows a folded topology representation of switches (networking nodes) of a computerized network, as involved in embodiments;

FIG. 4 schematically illustrates the mapping of data samples received from the switches onto a data structure (2D representation), according to an isomorphic transformation of a network topology of the switches, as involved in embodiments;

FIG. 5 schematically illustrates how starting and/or stopping the execution of the sampling mechanism can be performed, at each of the switches, according to a finite-state machine, as in embodiments;

FIG. 6 illustrates data queuing at a given switch and being processed (or forwarded) by such a switch, as involved in embodiments; and

FIG. 7 schematically represents a general purpose computerized system (e.g., an external entity), communicating with switches of a network, and suited for implementing method steps as involved in embodiments of the invention.

The accompanying drawings show simplified representations of systems (or parts thereof) and computerized methods, as involved in embodiments. Similar or functionally similar elements in the figures have been allocated the same numeral references, unless otherwise indicated.

### DETAILED DESCRIPTION OF EMBODIMENTS OF THE INVENTION

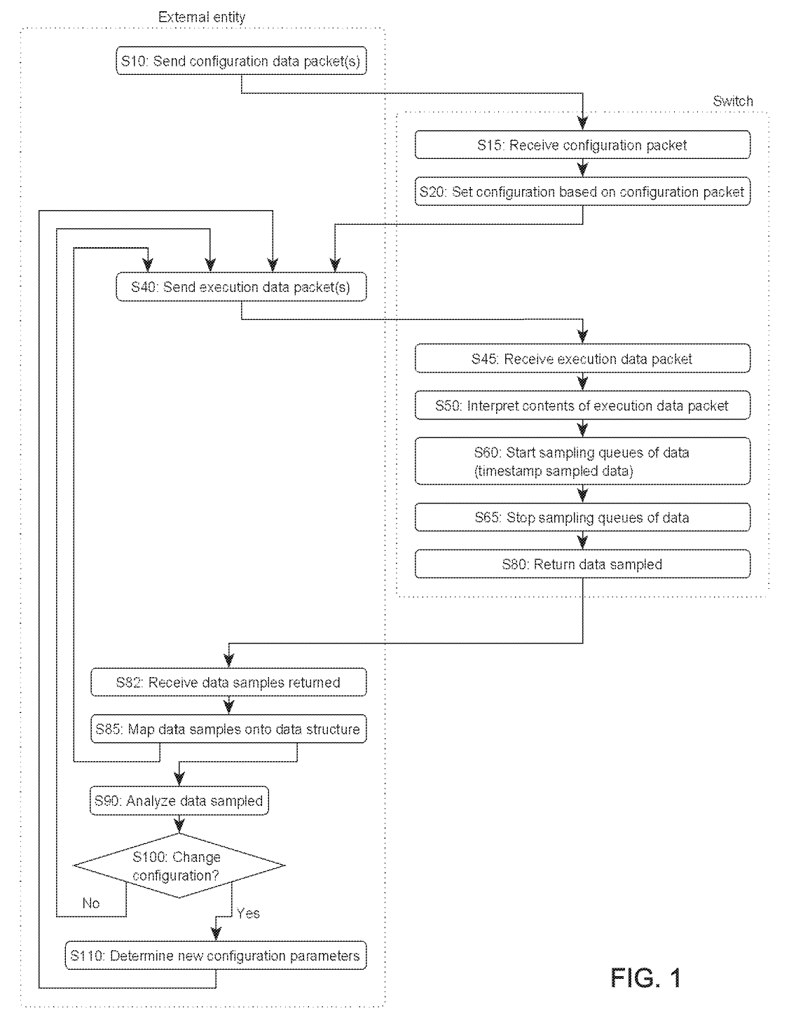

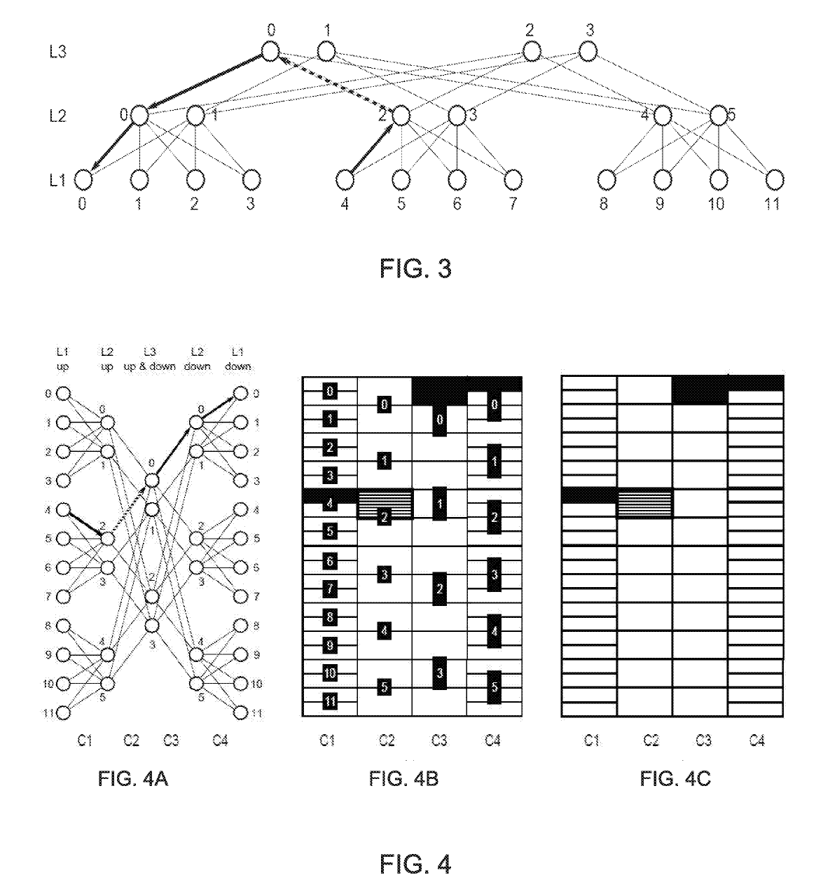

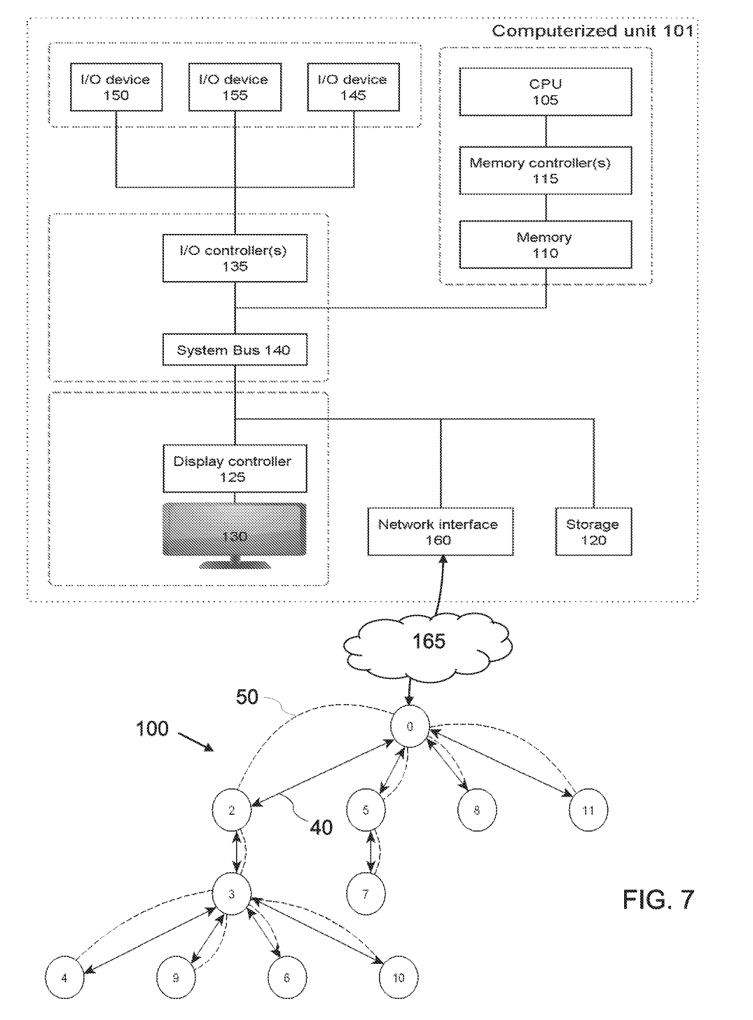

In reference to FIGS. 1-3, 6 and 7, an aspect of the invention is first described, which concerns a computer-implemented method for monitoring a computerized network 100. As seen in FIG. 3 or 7, the network 100 comprises several switches (e.g., labelled 0-11 in FIG. 7) that are, each, configured for processing data 21 23 queuing thereat (as illustrated in FIG. 6).

More in detail, present methods, as implemented at an entity 101 external to and in communication with the network 100, aim at monitoring queues 20 (and or 20a) of data 22, 23 and/or 19, see FIG. 6) at switches 0-11 of the network 100. The monitoring basically revolves around two main steps.

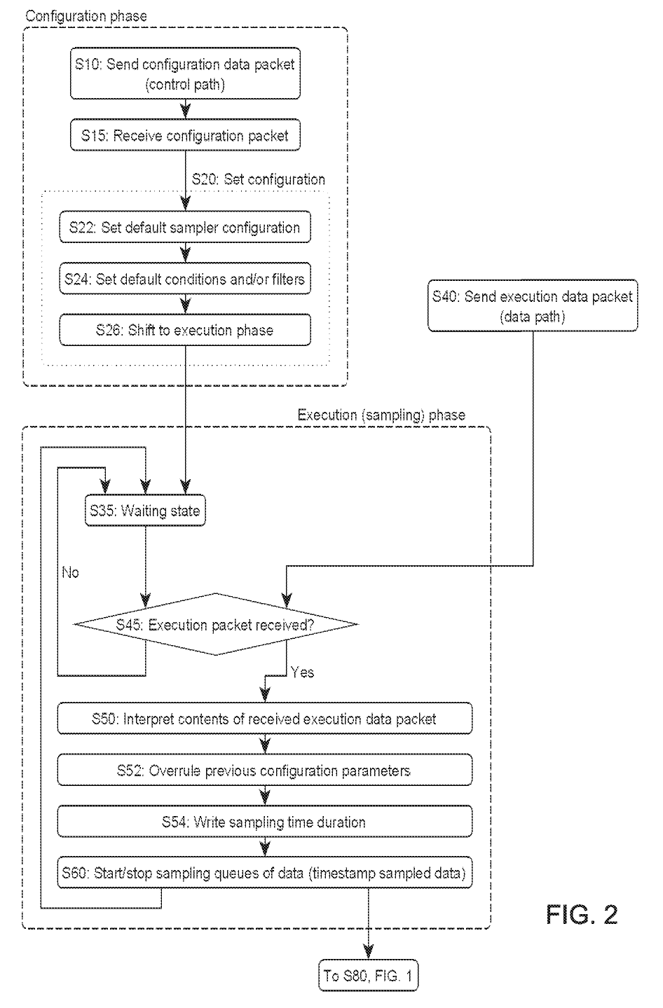

First, an execution data packet 21 is sent (step S40, see FIGS. 1 and 2), via a data path 40 of the network 100 to each of the switches 0-11. This execution data packet 21 comprises contents that are interpretable by each of the switches 0-11. Upon receiving an execution data packet 21, a switch may start S60 and/or stop S65 execution of a sampling mechanism for sampling a queue of data at said switch, and subsequently return S80 sampled data to the external entity 101.

Second, the external entity will accordingly receive S82, from each of the switches, and via said data path 40, data sampled according to said sampling mechanism.

Execution data packets are sent to the target switches, via a data path, which allows for both scalability and speed, as opposed to using a control path of the network. This way, the sampling mechanism can be globally started and/or stopped from the external entity 101. The external entity may for instance be hardware, i.e., a physical machine (e.g., a server, running the monitoring process), or software (e.g., a user application, implementing this monitoring process), or more generally, a set of machines (physical and/or virtual), interacting so as to implement the monitoring process. The external entity may for instance comprise one or more of: an operator, a user application, a monitoring entity, etc. The monitoring entity may also use the sampled data returned to perform specific operations or analyses thereon, as discussed later.

An execution data packet as defined above may be regarded as a global start signal (in which case sampling is started upon receiving the packet), and/or a global stop (in which case sampling is started beforehand but stopped upon receiving the packet). In all cases, using data packets sent along the data path of the network enable a global, scalable and fast sampling mechanism. The present monitoring scheme may accordingly find useful applications in the orchestration, management, load balancing, protection and isolation of clouds, distributed scale out systems and virtualized systems.

As noted above, the execution data packets may he used for triggering a global start and/or a global stop. Preferably yet, the execution data packets are designed to cause the switches to start sampling and include instructions for a programmable stop (the “stop” is automatic, as per instructions included in the execution packets). For example, the sampling S60 is limited to a given time period (as assumed in FIG. 6) and/or to a limited numbers of packets.

In (less preferred) variants, the execution data packets received may trigger a global stop signal. l.e., sampling would, in that case, be started prior to receiving an execution packet, e.g., based on previously received information. The sampling will accordingly cease upon receiving the data packet (or based on instructions included in this packet), such that a global mechanism can here again be implemented. However, a global stop mechanism will typically add complexity in terms of time synchronization.

In other (less preferred) variants, two data packets are sent, to respectively define the start and stop for the sampling mechanism. The sampling may start upon interpreting a first execution data packet received and finish upon interpreting a second execution data packet received. Such variants are nevertheless more complex to implement and consume more bandwidth.

As explained later in detail, an execution data packet may further include additional parameters, to cause the switches, upon reception and interpretation of the execution data packet, to set and/or update sampling configuration parameters. For instance, an execution data packet may include time data (beyond a mere time period for sampling) utilizable for synchronizing the sampling at the various switches, to enable a space-time correlated global sampling mechanism for a multitude of queues. This further makes it possible to subsequently synchronize the monitored data, at the external entity.

Moreover, different types of data packets may be used, which have distinct aims. The execution data packets aim at starting and/or stopping sampling of data queues at the switches and, if necessary, modifying a previously set sampling configuration (i.e., sampling parameters). In that respect, configuration data packets may be sent beforehand to the switches (steps S10, S15, prior to sending the execution data packets), e.g., using the control path instead of the data path, to pre-configure the switches. This way, default parameters for the sampling configuration (which may include sampling parameters and sampling conditions [as to what and when to sample]) may be set S22, S24 at the switches, prior to the execution phase S35-S60, FIG. 2. Such parameters may notably comprise information about which traffic flows are to be sampled, traffic flow described by data link, network, transport and/or application information. Thus, the subsequent sampling mechanism may, in embodiments, be regarded as a conditional sampling mechanism, inasmuch as the sampling may be triggered only if certain conditions (as set in S24) are met. Still, previously set S20 configuration parameters may be overruled S52 as per the execution data packets as received at steps S40-S45, i.e., the execution data packet may include updated configuration options for the sampling mechanism.

The steps S40 and S82 (at the external entity), and consistently the steps S45 and S80 (at the switches) are preferably repeatedly performed, to ensure a continuous or intermittent monitoring, while allowing changes intervening in the network to be taken into account. Indeed, the execution data packets sent during a subsequent execution phase may include new sampling configuration parameters, which take into account changes that have occurred since the last execution phase.

In variants, instructions for repeated sampling operations may already be included in a single execution packet (e.g., a one-time multicast packet) or in concomitantly sent unicast packets. Namely, a single execution packet may include instructions for the switch to perform repeated sampling operations, e.g., at given times or at regular time intervals, or, still, each time given conditions (e.g., as specified in the same packet or during a previous configuration phase S24) are met, where a conditional sampling mechanism is contemplated.

In all cases, a multicast or a unicast mechanism may be involved. For example, in a multicast scenario, the external entity may use a single IP address that identifies a group of switches. In a unicast scenario, distinct packets are sent to individual IP addresses of the switches.

The switches preferably implement a quantized congestion notification (QCN) protocol, or a related protocol, whereby components of the sampling mechanism obey such a protocol to perform the sampling. A switch that implements a QCN protocol or a similar protocol monitors its queues' sizes and rates of change of sizes. After starting the sampling process, a switch may “decide” (e.g., in a probabilistic manner and if deemed necessary, by way of some algorithm) to create a feedback notification packet containing data relevant to the queue and send the created packet to a suitable destination. The created feedback notification packets may be used as sampled data for implementing the present schemes. In embodiments, a feedback packet can be sent to the actual sources of the data packets in the monitored queue, which sources act as a distributed external entity. In other embodiments, the feedback data packet can be sent to a single, predefined physical external entity.

More generally though, the data sampled may, in particular, relate to queues of data to be processed (i.e., data queuing at the switches in view of being processed by them, like data packets 22, 23 in FIG. 6), and/or data 19 that have already been processed by the switches but which are buffered 20a in output, awaiting for dispatch. The data sampled may most simply relate to the size/occupancy of the queues, their evolution (fill rate) or any other temporal derivative thereof. The fill rate of a queue may for instance be estimated based on the rate of incoming packets vs. processed/leaving packets.

Note that not all the switches of an actual network may be targeted by the present monitoring methods. Instead, present methods may be implemented for a restricted set of switches (which would nonetheless form a network as defined above). In particular, the present principles are preferably applied to monitor queues at switches that are networking nodes (sometimes referred to as nodes, switches or routers, that is, entities that contribute to forward data traffic from a source to a destination), rather than end nodes that generate the data traffic (especially if input queues of switches are systematically and consistently sampled, as illustrated in FIG. 6). However, similar principles may, in variants, be applied to selected subsets of nodes, including nodes that produce data (e.g., by sampling output queues, as noted above).

The collection of the samples may be performed in a distributed manner (e.g., the switches return the samples according to an IP address of the external entity [e.g., as included in the received execution packets or according to instruction specified in such a packet]) or in a centralized way (the switches systematically return samples to a same recipient).

Referring now more specifically to FIG. 2 and FIG. 6, in embodiments, the execution data packets 21 sent S40 may comprise contents interpretable so as for the switches 10 to start S60 sampling S60 a queue 20 of data 22, 23 during a defined S54 time period t. Preferably, said time period is defined S54 according to contents of the execution data packet 21 received. Namely, by interpreting S50 contents in a received S45 execution data packet 21, a switch may read or compute S54 the applicable period of time, during which the sampling S60 is to be performed. The switches will subsequently return S80 data sampled during the defined time period to the external entity 101. For example, the packet 21 received by switch 10 in FIG. 6 may instruct the switch 10 to sample data packets 22, 23 queued in the queue 20 during the time period t starting after a given, predetermined time after interpretation of the contents of the packet 21 just received (at which time the packet 21 does not belong to the queue 20 anymore. In the simplest scenario, the sampling would restrict to counting the number of packets received during t (a few nanoseconds), i.e., 2 in the example of FIG. 6. In more sophisticated approaches, the rate of incoming (and possibly parting) packets may be taken into account as well. Other examples are given later. In FIG. 6, the packet 19 is assumed to have already been processed at the time packet 21 is being interpreted. At this time, packet 19 may be part of an output queue 20a, which, in variants, may he sampled (in addition to or in lieu of queue 20, in variants wherein output queues are sampled).

In the above scenario, sampling is typically started upon receiving the execution packets or based on instructions therein (e.g., if given conditions are met). By default, the time period may be set according to default parameters already provided to the switches, e.g., during the configuration phase S10-S26. Still, this time period may be overruled S52 by parameters included in the contents of the execution data packets 21 sent by the external entity 101.

If necessary, this time period can be dynamically adapted, e.g., according to a most recent state of the network traffic, as monitored from the external entity 101. Indeed, and prior to sending S40 an execution data packet, the external entity may determine (or update) S110 the time period according to data received S82 from one or more switches of the network, during a previous execution phase.

At present, the configuration phase is discussed in more detail, in reference to FIGS. 1 and 2. As evoked earlier, in embodiments, the monitoring process further comprises sending S10, from the entity 101, a configuration data packet to each of the switches (prior to sending an execution data packet). The configuration data packets can be sent via a control path 50 of the network 100, as the configuration phase is not as critical as the execution phase, in terms of temporality. A configuration data packet is interpretable by a switch so as for it to set S20 configuration parameters for the subsequent sampling S60. Thus, the reception S15 of the configuration data packet triggers a preliminary phase, during which switches are configured for the subsequent sampling phase.

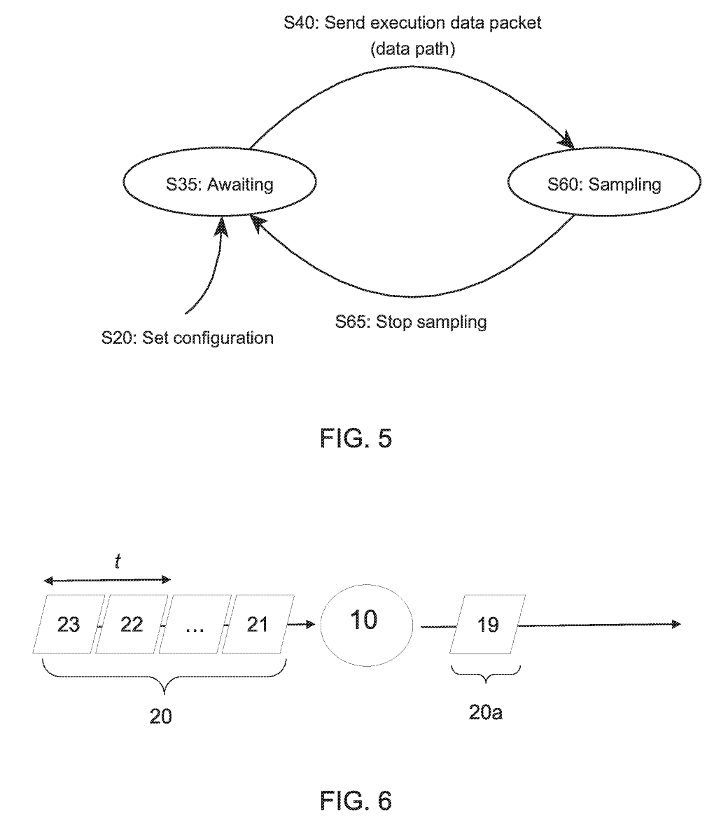

The sampling phase may start upon completion of the configuration phase, e.g., upon receiving the execution data packet triggering the global start for the sampling. However, switches are preferably configured as finite-state machines, whereby the completion of step S20 (where the configuration parameters are set) causes to shift S26 each switch in a state where it awaits S35 reception S45 of an execution data packet 21. As further illustrated in FIG. 5, switches will preferably maintain a finite-state machine behavior, beyond the configuration phase, when repeated sampling phases occur. Namely, starting and/or stopping the execution of the sampling mechanism S60 can be performed according to a finite-state machine (e.g., a Turing machine), whereby completion of a first sampling phase causes to shift S26 a switch in a state where it awaits S35 reception S45 of a subsequent execution data packet 21, and so on.

As discussed earlier, previous configuration parameters may be overruled at each new sampling phase S35-S60, as illustrated in FIG. 2, thanks to subsequently received S45 execution packets. For example, the sampling rules may be re-defined (e.g., to change data filters, sampler parameters, etc.), by a user or an application, in which case new configuration parameters are supplied within the execution packets. More generally, configuration parameters as set at step S20 (or as updated at steps S50-S52 may comprise one or more of: a number of packets to be sampled (e.g., a minimal number of packets); a total or minimal number of bytes to be sampled; or, still, one or more types of data to be sampled (or, conversely, one or more types of data that should not be sampled). Ports may be taken into consideration as well. For example, a configuration parameter may pertain to a total number of bytes per port, etc.

Practical monitoring applications are now discussed in reference to FIGS. 1 and 4. In general, practical analyses 590 of the data collected S80-S82 and subsequent configuration changes S100-S110 will be facilitated if the data samples received S82 from the switches are mapped S85 onto a data structure (suitable for subsequent automated analysis S90). To that aim, one may advantageously rely on an isomorphic transformation of the network topology of the switches, e.g., to map the collected data onto a multidimensional array (or more generally a multi-dimensional data structure). Then, the multi-dimensional data structure may, if needed, be represented as a map (e.g., a heat map, a density plot, a geospatial map, etc.).

In particular, and as illustrated in FIG. 4, the data samples collected S82 may be mapped S85 onto a heat map and the latter displayed to a user, an operator, etc., e.g., to enable time-synchronous snapshot images of the occupancy of the switch queues in the network. A heat map represents a 3D data structure as a structured image, where ‘pixels’ are color-coded (or otherwise patterned) so as to reflect a third dimension of the data structure. Yet, other visualization techniques may be used.

FIG. 4 illustrates a possible example of spatial mapping example, which mapping operation is known per se. Intermediate FIGS. 4A and 4B show how the extended generalized fat tree (hereafter XGFT) of FIG. 1 is mapped onto a heatmap in FIG. 4C. FIG. 4A unfolds and rotates the topology of FIG. 3 by 90 degrees. FIG. 3 illustrates a folded topology representation of an XGFT(3; 2,4,3; 1,2,2), where links are bidirectional. Node levels start at 0 from bottom to top (L0 to L3). Nodes within a level start at 0 from left to right. For simplicity reasons, only the switch levels (L1, L2, L3) are shown. L0 is populated with 2 (nodes)·12 (L1-switches)=24 (nodes). One particular path (from switch 4 on L1 to switch 0 on L1) is highlighted. The dashed link represents the upstream queue of port 0 at switch 2 on L2.

In the representation of FIG. 4A, links are unidirectional: the traffic flows from left to right. Each level corresponds to the up-/down-stream direction. All FIGS. (4A-4C) highlight the same exemplary path from switch 4 on L1 to switch 0 on L1. Similarly, the dashed link highlights the send queue(s) of port 0 at switch 2 of level 2 (L2). Each link level in FIG. 4A corresponds to a column in FIGS. 413 and 4C. Whereas, each cell in a column represents top-down the output queues ordered by: (i) the switch and (ii) the port within that switch. E.g., C3 shows the downstream output queues of the L3 switches: 4 switches·3 ports·1 queue=12 queues. Typical current switches have 1 to 4 hardware queues per port, but for clarity a single queue per port is assumed in this example (the one skilled in the art will nonetheless easily generalize this to several queues).

The mapping proposed in FIG. 4 is one of many possibilities to enable visual monitoring. Keeping in mind current screen resolutions and formats, one understand that hundreds to thousands of queues may be monitored, using an isomorphic transformation. However, automated analysis (e.g., as notably enabled by advanced computer-aided analysis) shall preferably rely on data mapped on multidimensional arrays (gathering many parameters per queue per switch, and if necessary per port). In general analyses made at step S90 may involve humans and/or machines.

Analysis S90 may precede a change in the configuration parameters for subsequent sampling phases. For instance, referring back to FIG. 1, after a first execution (sampling) phase, a further execution data packet 21 may be sent S40, still via the data path 40, to one or more switches, to trigger a new sampling phase. Note that different subset of switches may be targeted at each sampling phase, be it for statistical purposes. A further execution data packet may comprise modified contents with respect to packet sent S40 earlier. Contents may notably have been modified S110, based on an outcome of an analysis S90 of previously collected S82 data.

Referring again to FIGS. 1-3, 6 and 7 altogether, another aspect of the invention is now described, which concerns steps as implemented at the switches. Such steps can be viewed as the counterpart of the methods discussed so far, which were primarily directed to the external entity 101. In the methods described now, the purpose (enable an external entity 101 to monitor queues 20 of data 22, 23 at switches 0-11 of the network) and the technical context (switches process data 21-23 queuing thereat) remain the same.

Essentially, such methods echo steps S40 and S82 as described earlier. Namely, each of the switches (or a subset thereof) receives S45, via the data path 40 of the network, an execution data packet 21 and subsequently start S60 and/or stop S65 executing a sampling mechanism, according to contents of the execution data packet 21 received. Eventually, sampled data are returned S80 (still via the data path) to the external entity 101.

The sampling mechanism may rely on a quantized congestion notification protocol, or a related protocol, as noted earlier. For synchronization purposes, the switches preferably proceed to timestamp the data sampled. In fact, timestamping and routing/sending back data is typically performed continuously, for all data, including those data that get sampled as sampling starts. Also, and as described earlier, data are preferably sampled during a defined time period, which may be read or computed from contents of the execution data packet, or even set by default during the previous configuration phase.

In that respect, the switches may, in embodiments, be configured to set S20, during the configuration phase, configuration parameters for the subsequent sampling S60 (again according to contents of configuration data packets 21 received S45).

For completeness, and according to a final aspect, the invention may be embodied as a computer program product. This computer program product typically comprises a computer readable storage medium having program instructions embodied therewith, the program instructions being executable by one or more processors of an external (computerized) entity 101 to monitor queues of data at switches of the network, by performing steps S40 and S82 as discussed earlier in reference to FIGS. 1 and 2, as well as, if necessary, any one of steps S85-S110. This aspect of the invention is discussed in more detail later.

Computerized devices can be suitably designed for implementing embodiments of the present invention as described herein. In that respect, it can be appreciated that the methods described herein are largely non-interactive and automated. In exemplary embodiments, the methods described herein can be implemented either in an interactive, partly-interactive or non-interactive system. The methods described herein can be implemented in software (e.g., firmware), hardware, or a combination thereof. In exemplary embodiments, the methods described herein are implemented in software, as an executable program, the latter executed by suitable digital processing devices. More generally, embodiments of the present invention can be implemented wherein general-purpose digital computers, such as personal computers, workstations, etc., are used.

For instance, the computerized unit 101 depicted in FIG. 7 is a general-purpose computer, and may he regarded as being, hosting or otherwise enabling the functionalities of an “external entity” as defined earlier. In exemplary embodiments, in terms of hardware architecture, as shown in FIG. 7, the unit 101 includes a processor 105, memory 110 coupled to a memory controller 115, and one or more input and/or output (I/O) devices 145, 150, 155 (or peripherals) that are communicatively coupled via a local input/output controller 135. The input/output controller 135 can be, but is not limited to, one or more buses 140 or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 105 is a hardware device for executing software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), or generally any device for executing software instructions.

The memory 110 can include any one or combination of volatile memory elements (e.g., random access memory) and nonvolatile memory elements. Moreover, the memory 110 may incorporate electronic, magnetic, optical, and/or other types of storage media. Note that the memory 110 can have a distributed architecture, where various components are situated remote from one another, but can be accessed by the processor 105.

The software in memory 110 may include one or more separate programs, each of which comprises an ordered listing of executable instructions for implementing logical functions. In the example of FIG. 7, the software in the memory 110 includes methods described herein in accordance with exemplary embodiments and a suitable operating system (OS). The OS essentially controls the execution of other computer programs and provides scheduling, input-output control, file and data management, memory management, and communication control and related services.

The methods described herein may be in the form of a source program, executable program (object code), script, or any other entity comprising a set of instructions to be performed. When in a source program form, then the program needs to be translated via a compiler, assembler, interpreter, or the like, as known per se, which may or may not be included within the memory 110, so as to operate properly in connection with the OS. Furthermore, the methods can be written as an object oriented programming language, which has classes of data and methods, or a procedure programming language, which has routines, subroutines, and/or functions.

Possibly, a conventional keyboard 150 and mouse 155 can be coupled to the input/output controller 135. Other I/O devices 145-155 may include other hardware devices.

In addition, the I/O devices 145-155 may further include devices that communicate both inputs and outputs. The unit 101 can further include a display controller 125 coupled to a display 130. In exemplary embodiments, the unit 101 can further include a network interface or transceiver 160 for coupling directly to the network 100 or (as assumed in FIG. 7) to an intermediate network 165, and in turn communicate with switches 0-11 of the network 100.

The network 165 transmits and receives data between the unit 101 and the network 100. Each of the networks 100 and 165 may possibly implemented in a wireless fashion, e.g., using wireless protocols and technologies, such as WiFi, WiMax, etc. The network 100 or 165 may be a fixed wireless network, a wireless local area network (LAN), a wireless wide area network (WAN) a personal area network (PAN), a virtual private network (VPN), intranet or other suitable network system and includes equipment for receiving and transmitting signals. The network 100 or 165 can also be an IP-based network for communication between the unit 101 and any external server, client and the like via a broadband connection. In exemplary embodiments, the network 100 or 165 can be a managed IP network administered by a service provider. Besides, the network 100 is packet-switched network such as a LAN, WAN, Internet network, etc. The network 165 is preferably a packet-switched network too.

If the unit 101 is a PC, workstation, intelligent device or the like, the software in the memory 110 may further include a basic input output system (BIOS). The BIOS is stored in ROM so that the BIOS can be executed when the computer 101 is activated.

When the unit 101 is in operation, the processor 105 is configured to execute software stored within the memory 110, to communicate data to and from the memory 110, and to generally control operations of the computer 101 pursuant to the software. The methods described herein (in respect of the entity 101) and the OS, in whole or in part are read by the processor 105, typically buffered within the processor 105, and then executed. When the entity methods described herein (in respect of the entity 101) are implemented in software, the methods can be stored on any computer readable medium, such as storage 120, for use by or in connection with any computer related system or method.

In addition, the present invention may be embodied as a computer program product, as evoked above. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may he assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the C programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In sonic alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the present invention has been described with reference to a limited number of embodiments, variants and the accompanying drawings, it will be understood by those skilled in the art that various changes may be made and equivalents may be substituted without departing from the scope of the present invention. In particular, a feature (device-like or method-like) recited in a given embodiment, variant or shown in a drawing may be combined with or replace another feature in another embodiment, variant or drawing, without departing from the scope of the present invention. Various combinations of the features described in respect of any of the above embodiments or variants may accordingly be contemplated, that remain within the scope of the appended claims. In addition, many minor modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims. In addition, many other variants than explicitly touched above can be contemplated.

What is claimed is:

1. A computer-implemented method for monitoring a computerized network, wherein said network comprises several switches that are, each, configured for processing data queuing thereat, the method comprising, at an entity external to and in communication with the network, monitoring queues of data at switches of the network, by:
sending, via a data path of the network, an execution data packet to each of the switches, said execution data packet comprising contents interpretable by said each of the switches so as for the latter to start and/or stop an execution of a sampling mechanism for sampling a queue of data at said each of the switches and returning sampled data to the external entity; and
receiving from each of the switches, via said data path, data sampled according to said sampling mechanism.

2. The method of claim 1, wherein:
the execution data packet sent comprises contents interpretable so as for said each of the switches to start the execution of the sampling mechanism for sampling said queue during a defined time period and returning data sampled during that time period to the external entity.

3. The method of claim 2, wherein
said time period is defined according to the contents of the execution data packet sent.

4. The method of claim 3, further comprising, prior to sending said execution data packet,
determining, at the external entity, said time period according to sampled data as previously received from one or more switches of the network.

5. The method of claim 1, wherein monitoring further comprises:
sending, prior to sending said execution data packet, a configuration data packet to said each of the switches, via a control path of the network, said configuration data packet interpretable so as for said each of the switches to set configuration parameters for the subsequent execution of the sampling mechanism.

6. The method of claim 5, wherein
the configuration data packet sent to said each of the switches is further interpretable so as for said each of the switches to shift in a state wherein said each of the switches is awaiting reception of an execution data packet, after having set said configuration parameters.

7. The method of claim 5, wherein said configuration parameters comprise one or more of:
a number of packets to be sampled;
a minimal number of packets to be sampled;
a total number of bytes to be sampled;
a minimal number of bytes to be sampled;
a type of data to be sampled; and
a type of data to be not sampled.

8. The method of claim 1, further comprising, at the external entity:
mapping the data samples received from the switches onto a data structure, according to an isomorphic transformation of a network topology of said switches.

9. The method of claim 8, wherein
at mapping, the data samples are mapped onto a multi-dimensional data structure, and wherein,
the method further comprises, at the external entity:
representing the multi-dimensional data structure as a map.

10. The method of claim 8, wherein monitoring queues of data at switches of the network further comprises:
sending, via said data path, a further execution data packet to one of the switches of the network, said further execution data packet comprising modified contents interpretable by said one of the switches, wherein said contents have been modified with respect to contents of an execution data packet as previously sent to said one of the switches, based on an outcome of an analysis of said data structure.

11. The method of claim 1, wherein
monitoring queues of data at switches of the network comprises repeatedly performing, via said data path, the steps of: sending an execution data packet to each of the switches; and receiving data sampled from each of the switches.

12. The method of claim 1, wherein
sending an execution data packet to each of the switches is performed by multicasting said execution data packet to each of the switches.

13. A computer-implemented method for enabling an entity external to and in communication with a computerized network to monitor queues of data at switches of the network, wherein said network comprises several switches that are, each, configured for processing data queuing thereat, the method comprising, at each of the switches of the network:
receiving, via a data path of the network, an execution data packet;
starting and/or stopping an execution of a sampling mechanism for sampling a queue of data at said each of the switches, according to contents of the execution data packet received; and
returning, via said data path, data sampled according to said sampling mechanism to the external entity.

14. The method of claim 13, further comprising
timestamping data sampled.

15. The method of claim 13, wherein
the execution data packet received comprises contents interpretable so as for said each of the switches to start the execution of the sampling mechanism for sampling said queue during a defined time period and returning data sampled during that time period to the external entity.

16. The method of claim 13, wherein
the method further comprises, at each of the switches of the network:
receiving, prior to receiving said execution data packet, a configuration data packet, via a control path of the network; and
setting configuration parameters for the subsequent execution of the sampling mechanism, according to contents of the configuration data packet received.

17. The method of claim 13, wherein
starting and/or stopping the execution of the sampling mechanism is performed, at said each of the switches, according to a finite-state machine, whereby completing execution of the sampling mechanism causes to shift said each of the switches in a state wherein it awaits reception of a subsequent execution data packet for starting and/or stopping an execution of a further sampling mechanism for sampling a queue of data at said each of the switches, according to contents of said subsequent execution data packet.

18. The method of claim 13, wherein
the started and/or stopped execution of the sampling mechanism comprises execution of components of said sampling mechanism that rely on a quantized congestion notification protocol implemented by the switches.

19. A computer program product for monitoring a computerized network that comprises several switches that are, each, configured for processing data queuing thereat, the computer program product comprising a computer readable storage medium having program instructions embodied therewith, the program instructions being executable by one or more processors of an entity external to and in communication with the network, to cause said external entity to monitor queues of data at switches of the network, by
sending, via a data path of the network, an execution data packet to each of the switches, said execution data packet comprising contents interpretable by said each of the switches so as for the latter to start and/or stop an execution of a sampling mechanism for sampling a queue of data at said each of the switches and returning sampled data to the external entity; and
receiving from each of the switches, via said data path, data sampled according to said sampling mechanism.
